(19) United States
(12) Patent Application Publication
(10) Pub. No.: US 2004/0054072 A1
(43) Pub. Date: Mar. 18, 2004

(54) Polymer-based floor-coating agent free of metal salts

(76) Inventors: Karl-Heinz Rogmann, Ratingen (DE); Ulrike Scheuvens, Langefeld (DE); Heiko Faubel, Wermelskirchen (DE)

Correspondence Address: Andrew S Sorensen, Ecolab Inc, Research & Development Center, 840 Sibley Memorial Highway, Mendota Heights, MN, 55118, US

(21) Appl. No.: 10/451,495

(22) PCT Filed: Dec. 11, 2001
(86) PCT No.: PCT/EP01/14513

(30) Foreign Application Priority Data
Dec. 20, 2000 (DE) 100 63 431.1

(51) Int. Cl. C08K 3/00

(52) U.S. Cl. 524/589

(57) ABSTRACT

Aqueous, polymeric floor coating agent that is substantially free from metal salts, containing

a) a polyurethane component in the production of which a polyol mixture has been used in which partially dehydrated castor oil with a hydroxyl number of 90 to 130 mg KOH per g of substance is present as a constituent, and

b) an emulsion polymer as film-forming component, the effect of which is that a resulting coating can be removed or stripped off by using an acid or alkali, based on

i) a first portion of polymerized units that contain either an acid group or an amino group, having the effect that the particles of the emulsion polymer swell when treated with an amine group-containing polish remover (including ammonia) or with an acidic polish remover, and

ii) a second portion of polymerized units that contain a functional group that permits an inter-molecular, covalent crosslinking of the polymer, either by direct reaction between these crosslinking groups or by means of a covalently crosslinking agent that can react with these crosslinking groups and is present in the composition, wherein such an inter-molecular covalent crosslinking of the polymer taking place either before or during the deposition of the film on the substrate.

The present invention relates to an aqueous, polymeric floor coating agent that according to its formulation does not include metal salts, containing a special polyurethane component as well as an emulsion polymer as film-forming component, the effect of which is that a resulting coating can be stripped or removed by using an acid or alkali. The present invention also relates to the use of the aforementioned special polyurethane component in order to improve the hard-wearing behavior and/or durability of floor coatings.

New, still untreated floors and the like that have undergone a thorough cleaning are nowadays almost always treated with special care emulsions in order to protect them against soiling and damage. These floor coating agents, which as a rule contain wax and/or film-forming polymers of variable compositions, form closed, dirt-repellent films on the floor after they have dried. Films that contain a high proportion of wax can in addition easily be polished and can also readily be removed from the surfaces as and when necessary, while films that consist largely or completely of film-forming polymers are particularly resistant to mechanical stress. The mechanical toughness is an important criterion in practical applications.

The polymer compounds used to improve the mechanical toughness are often those that are at least partially insoluble in water at neutral pH value and that have a minimum film-forming temperature in the range between about 0 and 90° C. These compounds are preferably polymers that are produced from ethylenically unsaturated monomers. Examples of such monomers include styrene, acrylic acid esters or methacrylic acid esters of aliphatic alcohols containing 1 to 8 C atoms, acrylonitrile, vinyl acetate, acrylic acid and methacrylic acid. Particularly preferred are poly(meth)acrylates of two or more of these monomers, which may optionally also contain further monomers in minor amounts. Most particularly preferred polymers contain 1 to 30 parts by weight of monomers containing carboxylic acid groups, 30 to 70 parts by weight of monomers that form homopolymers having glass transition temperatures of around 20° C., preferably esters of acrylic acid with C₁-C₈ alcohols and/or of methacrylic acid with C₄-C₈ alcohols, and 30 to 70 parts by weight of monomers that form homopolymers with glass transition temperatures above room temperature, preferably methacrylic acid esters of C₁-C₃ alcohols or styrene. If several different polymer compounds of the aforementioned type are used as a mixture in the polymer dispersion, then the measured film-forming temperature of the mixture should be in the range between 0 and 70° C. The aforementioned film-forming temperatures refer to the plasticizer-free system, i.e. to the polymers without further additives. Examples of such film-forming polymers are the following commercial products available as dispersions: Licomer A 41® (Clariant), Neocryl A 349 (Avecia) and Primal B 527® (Rohm & Haas).

On account of the difficulty in removing polymers containing carboxylate groups, heavy metal ions, for example zinc ions, are added to solve this problem, which form particularly resistant films after drying. Examples of commercially available polymer dispersions that contain metal salts are Ubatol DW 3081 (Cray Valley), Neocryl SR 267® (Avecia) and Primal B 1604® (Rohm & Haas). Metal-crosslinked polymer floor coatings based on such polymer dispersions can easily be removed as and when required.

As a further type of film-forming polymers that can be used together with poly(meth)acrylates, polyurethanes must be mentioned, which likewise are commercially available for this purpose. Examples of suitable polyurethane dispersions are for example Alberdingk U 210 W® (Alberdingk Boley) and Neorez 986® (Avecia).

The polymers are preferably contained in amounts of between 10 and 35 wt. %, in particular between 11 and 20 wt. %. These figures refer to the pure polymers. If dispersed polymers have already been used as starting materials in the production of the dispersions, as is often the case in commercially available dispersions, then correspondingly larger amounts of these dispersions should be used in the production of the coating agents. Polyurethanes may be contained in an amount of up to 15 wt. %, preferably 1 to 8 wt. %, in the coating agents.

The use of metal-containing polymers brings, in addition to the advantages of mechanical strength and removability, also problems. For example, such metal-containing floor coating agents contain an excess of volatile amines that are designed to chelate completely the respective metal, preferably zinc, and thereby avoid a three-dimensional crosslinking of the polymer before the application. The high content of volatile amines gives rise to problems in handling and application on account of the smell and toxicity of the generally volatile amines.

In addition there is the problem that, on account of the content of transition metals and the associated environmental aspects, this type of floor coating agent is ecologically questionable.

In European Patent EP 438 216 A2 a coating agent is described that is substantially free of metal salts and that can easily be removed. According to EP 438 216 A2 this coating agent does not have the ecological problems associated with metals and volatile amines. EP 438 216 A2 basically discloses a polymer composition containing swellable emulsion polymer particles that are crosslinked to such an extent before the film formation that the polymers are still able to form a film during the application that can subsequently be removed by using a solution containing swelling agents for the polymer particles. In other words, the swollen film loses its cohesion if it has to be removed, and can therefore easily be stripped off. However, as can be seen from the examples of the present invention, floor coatings that have been produced from agents based on substantially metal-free polymers according to EP 438 216 A2 exhibit weaknesses as regards the mechanical toughness as well as the durability and wear-resistance of the film on the floor. These weaknesses become particularly evident when formulations according to EP 438 216 A2 are directly compared with formulations based on polymers that are substantially free of metals. As is known and also follows from the examples, an improvement in the mechanical toughness as well as the wear-resistance and durability of floor coatings based on metal-crosslinked polymers can be achieved by adding relatively large amounts of polyurethane, namely more than 10 wt. % based on the total floor coating agent. With such large amounts of polyurethane however a deterioration in the removability of the coating has to be accepted. If however relatively small amounts of polyurethane, for example 5 wt. % based on the total floor coating agent are used, then scarcely any improvement in the criteria of mechanical toughness and wear or durability can be discerned. The results given above are based on experiments with aqueous/petrochemical-based polyurethane, for example with the product Neorez R 974.

The object of the present invention is accordingly to provide floor coating agents that according to their formulation are free from metals, in which connection the resulting floor coating should be of high quality, in particular with regard to mechanical toughness, resistance to wear and durability, as well as ease of removability. It has surprisingly been found that the desired properties can be achieved by using specific polyurethane components in a polymeric floor coating agent formulated so as to be free from metal salts. The present invention accordingly provides an aqueous, polymeric floor coating agent that according to its formulation is free from metal salts, containing

a) a polyurethane component in the production of which a polyol mixture has been used in which partially dehydrated castor oil with a hydroxyl number of 90 to 130 mg KOH per g of substance is present as constituent, and

b) an emulsion polymer as film-forming component, the effect of which is that a resulting coating can be removed or stripped off by using an acid or alkali, based on

i) a first portion of polymerized units that contain either an acid group or an amino group, having the effect that the particles of the emulsion polymer swell when treated with an amine group-containing polish remover (including ammonia) or with an acidic polish remover, and

ii) a second portion of polymerized units that contain a functional group that permits an inter-molecular, covalent crosslinking of the polymer, either by direct reaction between these crosslinking groups or by means of a covalently crosslinking agent that can react with these crosslinking groups and is present in the composition, such an inter-molecular covalent crosslinking of the polymer taking place either before or during the deposition of the film on the substrate.

The term polish remover is understood by the person skilled in the art to mean a strong cleansing agent that is used to remove coatings.

As has already been mentioned in the introduction, the emulsion polymer b) is already known from EP 4.38 216 A2. The polyurethane component a) is disclosed in DE 44 38 351 A1.

However, nothing in EP 438 216 A2 or DE 44 38 351 A1 discloses or suggests that, by combining the aforementioned components, an agent could be provided that would achieve such good results as regards the mechanical toughness, susceptibility to wear and durability and also ease of removal of the resulting floor coating. This was completely surprising and unexpected. In order to determine the hydroxyl number of the castor oil, the latter is generally boiled with acetic anhydride and pyridine, and the acid that is formed is titrated with KOH solution. More detailed descriptions can be found for example in various Standards such as DIN 53 240 (12/1971) or DIN ISO 4629 (11/1979).

Partially dehydrated castor oil with a hydroxyl number of 110 to 125 mg KOH per g of substance is preferably used in the production of the polyurethane a) contained in the coating agent according to the invention.

In this connection it is also preferred if, in the production of the polyurethane a), the partially dehydrated castor oil is present in a proportion of 25 to 100 wt. %, based on the polyol component of the polyurethane. The partially dehydrated castor oil is preferably a constituent of a mixture with a polyester polyol, a polyether polyol, a polyester polyether polyol, or a mixture of a polyester polyol and polyether polyol, the molecular weight of the polyol being in the range from about 400 to 6000 particularly preferably about 1000 to 3000, and the molecular weight of the polyether polyols being about 1000 to 2000.

Preferably the polyurethane a) in the agent according to the invention is present in an amount of 1 to 10 wt. %, particularly preferably 1 to 7 wt. %, in particular 1 to 5 wt. % based on the total floor coating agent.

In a further preferred embodiment of the present invention the emulsion polymer b) included in the agent according to the invention contains 3 to 35 wt. %, preferably 5 to 30 wt. % based on the total weight of the polymer, of solid polymerized units that contain an acid group, preferably a carboxylic acid group, having the effect that the emulsion polymer particles swell if they are treated with an amine group-containing polish remover (including ammonia), as well as in addition 0.15 to 12 wt. % of polymerized units that provide the crosslinking functionality.

It is furthermore preferred if the emulsion polymer b) included in the agent according to the invention contains 3 to 30 wt. %, preferably 5 to 20 wt. % based on the weight of the polymer, of polymerized units that have a primary, secondary or tertiary amino group, having the effect that the resulting emulsion polymer particles swell when they are treated with an acidic polish remover, as well as in addition 0.2 to 9.0 wt. % of polymerized units that provide the crosslinking functionality.

Preferably the film-forming component b) accounts for 10 to 40 wt. %, particularly preferably 12 to 30 wt. %, based on the total floor coating agent.

It is likewise preferred if, referred to the total floor coating agent according to the invention, the said agent additionally contains

a) up to 3 wt. % of wax dispersion, preferably based on polyethylene, and/or

b) up to 3 wt. % of flow control agents, preferably based on non-ionic surfactants, and/or

further auxiliary substances and active agents such as conventional temporary plasticizers, for example monohydric or polyhydric alcohols, conventional permanent plasticizers, for example tributoxyethyl phosphate, further conventional additives, for example preservatives as well as water.

Plasticizers serve to modify the consistency of the film, in which connection a distinction should be made between temporary plasticizers and permanent plasticizers. Temporary plasticizers are volatile hydrophilic solvents that promote the confluence of the polymer particles in the film formation. Examples are ethylene glycol, diethylene glycol as well as glycol ethers and polyglycol ethers. Their proportion in the agents according to the invention is generally not more than 15 wt. %, and is preferably between 0.5 and 10 wt. %. Permanent plasticizers are liquids that are not volatile under normal conditions, so that with their help the state and condition of the surface treatment film can be influenced in a sustained manner. Examples of such plasticizers are dibutyl phthalate, tributyl phosphate, tributoxyethyl phosphate and N-methylcaprolactam. This type of plasticizer too is generally contained in an amount of not more than 15 wt. % in the suspensions according to the invention. A content of 0.5 to 10 wt. % is preferred.

Wetting agents and flow control agents serve to improve the wetting of the treated surface during the application of the dry-bright emulsion; also, the dilution of the agents with water, for example when they are applied to damp floors, is thereby facilitated. The usual surfactants may be used, in particular non-ionic and anionic surfactants, for example ethoxylates of long-chain alcohols or alkylbenzenesulfonates and fatty alcohol sulfates. The content of wetting agents and flow control agents is in general not more than 5 wt. % based on the total weight of the dry-bright emulsion. The content is preferably between 0.1 and 2 wt. %. Also, the wetting of the surface during application can be improved with the aid of wetting resins. These resins are preferably styrene-maleate resins or clear polyacrylates. Their content in the agents is generally not above 5 wt. %, and is preferably between 0.1 and 2 wt. %.

The agents can be produced by conventional mixing processes. In general a pre-prepared polymer dispersion such as can be obtained commercially is used as starting material, or a dispersion of the polymer in water is prepared in a manner known per se. If the dry-bright emulsion is also to contain wax, the latter can first of all be processed separately to form an emulsion in water, optionally with the addition of suitable wax emulsifiers, and then added in this form to the polymer dispersion. The remaining constituents can then be added to this mixture while stirring. The pH of the agent is adjusted if necessary by means of alkalis or acids to the desired value in the neutral pH range (pH 5 to pH 9).

The dry-bright emulsions according to the invention are as a rule used undiluted. The emulsions are applied to the surface, where they are uniformly distributed in the desired amount using a soft object, for example a sponge or a cloth. With this treatment process an extremely uniform shiny protective film remains after evaporation of the water.

It is most particularly preferred in this connection that the agent according to the invention be substantially free from fluorine-containing wetting agents and flow control agents. This group of chemicals can thus also be omitted in this preferred embodiment, and as a consequence the ecological acceptance of floor coating agents according to the invention is enhanced even more.

Preferably in the emulsion polymer b) contained in the agent according to the invention the proportion of the polymerized units ii), which impart the crosslinking function, is such that, after crosslinking has taken place, the slope of the curve of tan δ against the temperature of the crosslinked polymer in the rubber state plateau has a value of 3.00×10⁻³ to −0.20×10⁻³. As regards the significance and measurement of tan δ, reference may be made at this point to EP 438 216 A2, p. 6, line 48 to p. 7, line 16.

The present invention also provides for the use of polyurethane in the production of which a polyol mixture has been used containing as a constituent partially dehydrated castor oil with a hydroxyl number of 90 to 130 mg KOH, preferably 110 to 125 mg KOH per g of substance, in order to improve the hard-wearing behavior and/or the durability of floor coatings. Hard-wearing behavior is generally understood to mean the mechanical toughness and also the resistance to wear.

In a preferred embodiment of the use according to the invention, in the production of the polyurethane a) the partially dehydrated castor oil is present in an amount of 25 to 100 wt. % based on the polyol component of the polyurethane.

Moreover, the comments already made in connection with the agents according to the invention also apply to the preferred features of the polyurethane to be used according to the invention.

### Examples

TABLE 1
Formulations of floor coating agents
[all proportions in wt. %]

| | Ref. | Ref. | Ref. | Ref. | Ref. | Inven- | Inven- |
|---|---|---|---|---|---|---|---|
| | 1 | 2 | 3 | 4 | 5 | tion | tion |
| Raw Material | % | % | % | % | % | E1/% | E2/% |
| Zn-crosslinked | 18 | 20 | 19 | 18 | — | — | — |
| polyacrylate | | | | | | | |
| Wax dispersion | 4 | 3 | 3 | 2 | 3 | 3 | 3 |
| Petrochemical- | — | — | ca. 2 | ca. | ca. 5 | — | — |
| based | | | | 11 | | | |
| polyurethane | | | | | | | |
| dispersion | | | | | | | |
| [Neorez 986•] | | | | | | | |
| Styrene maleate | — | 2 | — | — | — | — | — |
| Niosurfactant: | — | — | — | — | — | — | 0.5 |
| fatty alcohol with | | | | | | | |
| 6-7 ethylene | | | | | | | |
| oxide groups | | | | | | | |
| Fluorinated | ca. | ca. | ca. | ca. | — | — | — |
| surfactant | 0.1 | 0.1 | 0.1 | 0.1 | | | |
| [Fluorad FL | | | | | | | |
| 129] = ethyl-N- | | | | | | | |
| perfluoro-octyl- | | | | | | | |
| sulfonylamino- | | | | | | | |
| acetic acid K salt | | | | | | | |
| Non-metal- | — | — | — | — | 20 | 20 | 20 |
| crosslinked | | | | | | | |
| polyacrylate | | | | | | | |
| according to EP | | | | | | | |
| 438 216 A2 | | | | | | | |
| Polyurethane | — | — | — | — | — | ca. | 1.5 |
| dispersion based | | | | | | 1.5 | |
| on renewable raw | | | | | | | |
| materials | | | | | | | |
| according to DE | | | | | | | |
| 44 38 351 A1 | | | | | | | |

Remainder to 100 wt. %: water and further
conventional substances* for floor coating agents
*For example permanent plasticizers (optionally tributoxyethyl phosphate), temporary plasticizers (such as ethylene glycol), flow control agents (such as non-ionic surfactants or other wetting agents)

TABLE 2
Results in application technology use with the
reference floor coating agents Ref. 1 to Ref. 5,
as well as the floor coating agents E1 and E2
according to the invention

| | | Ref. | Ref. | Ref. | Ref. | Ref. | | |
|---|---|---|---|---|---|---|---|---|
| | Test Parameter | 1 | 2 | 3 | 4 | 5 | E1 | E2 |
| A | Hard-wearing | 0 | −0.5 | −2 | +0.5 | −1.5 | 0 | 0 |
| | behavior | | | | | | | |
| | (scuffing, marks, | | | | | | | |
| | scratches) | | | | | | | |
| B | Wear/durability | 0 | 0 | −1 | 0 | −1 | 0 | 0 |
| C | Wetting/flow | 0 | 0 | −0.5 | 0 | −0.5 | 0 | +0.5 |
| | behavior | | | | | | | |
| D | Water/wiping | 0 | 0 | 0 | −0.5 | 0 | 0 | 0 |
| | resistance | | | | | | | |
| E | Removal/ | 0 | 0 | 0.5 | −2 | 0 | 0 | 0 |
| | stripping | | | | | | | |
| F | High speed | 0 | +0.5 | +1 | −1 | +0.5 | +0.5 | +0.5 |
| | polishing | | | | | | | |
| | behavior | | | | | | | |
| G | Surface dirt | 0 | 0 | −0.5 | 0 | 0 | 0 | 0 |
| | accumulation | | | | | | | |
| H | Wiping behavior | 0 | −0.5 | 0 | 0 | 0 | 0 | 0 |
| | of the treatment | | | | | | | |
| | film/water | | | | | | | |
| | repellence | | | | | | | |

In order to evaluate the criteria listed in Table 2, the floor coating agents Ref. 1 to Ref. 5 and E1 as well as E2 were uniformly distributed in amounts of in each case 10 ml using a manual application device to seven 30×60 cm large PVC plates. The PVC plates coated with the respective floor coating agent were tested under comparable conditions in practice at extremely high frequency of use, more specifically about 3000 “treads/day” over a period of 100 days.

The results are assessed by trained staff visually evaluating the quality criteria of the floor coating. In this connection the evaluation scale ranges from +2 (=excellent) to 0 (good standard in practice) down to −2 15 (very poor). In particular it should be mentioned that the aim is for all evaluation criteria to obtain a score of 0 or above. Accordingly, the reference agent 1, which in Table 2 achieves a score of 0 in all the evaluation criteria, is the most successful product on the market at the time of the invention.

Despite the small proportion of polyurethane the PVC plates coated with El have a covering that exhibits good hard-wearing behavior as well as durability and low tendency to wear. In addition the removability of the film is also good and the flow behavior satisfies the practical requirements despite the absence of fluorinated surfactants. In the tests involving E2 there was even an improvement of the wetting/flow behavior, the other values being the same as in E1.

A floor coating that achieved in all the relevant criteria the values of the hitherto conventional agents based on metal-crosslinked polymers was surprisingly obtained for the first time by the combination according to the invention, without using metal-crosslinked polymers.

1. An aqueous, polymeric floor coating agent that according to its formulation is free from metal salts, containing
a) a polyurethane component in the production of which a polyol mixture has been used in which partially dehydrated castor oil with a hydroxyl number of 90 to 130 mg KOH per g of substance is present as constituent, and
b) an emulsion polymer as film-forming component, the effect of which is that a resulting coating can be removed or stripped off by using an acid or alkali, based on
i) a first portion of polymerized units that contain either an acid group or an amino group, having the effect that the particles of the emulsion polymer swell when treated with an amine group-containing polish remover (including ammonia) or with an acid polish remover, and
ii) a second portion of polymerized units that contain a functional group that permits an inter-molecular, covalent crosslinking of the polymer, either by direct reaction between these crosslinking groups or by means of a covalently crosslinking agent that can react with these crosslinking groups and is present in the composition, wherein such an inter-molecular covalent crosslinking of the polymer taking place either before or during the deposition of the film on the substrate.

2. An agent according to claim 1, characterized in that partially dehydrated castor oil with a hydroxyl number of 110 to 125 mg KOH per g of substance is used in the production of the polyurethane a).

3. An agent according to either claim 1 or claim 2, characterized in that the partially dehydrated castor oil used in the production of the polyurethane a) is present in a proportion of 25 to 100 wt. % based on the polyol component of the polyurethane.

4. An agent according to one of claims 1 to 3, characterized in that the polyurethane a) makes up 1 to 10 wt. %, preferably 1 to 7 wt. %, particularly preferably 1 to 5 wt. %, based on the total floor coating agent.

5. An agent according to one of claims 1 to 4, characterized in that the emulsion polymer b) contains 3 to 35 wt/%, preferably 5 to 30 wt. % based on the total weight of the polymer, of polymerized units that contain an acid group, preferably a carboxylic acid group, with the effect that the emulsion polymer particles swell when they are treated with an amine group-containing polish remover (including ammonia), and 0.15 to 12 wt. % of polymerized units that provide the crosslinking functionality.

6. An agent according to one of claims 1 to 4, characterized in that the emulsion polymer b) contains 3 to 30 wt. %, preferably 5 to 20 wt. % based on the weight of the polymer, of polymerized units that contain a primary, secondary or tertiary amino group, with the effect that the resulting emulsion polymer particles swell when they are treated with an acidic polish remover, and 0.2 to 9.0 wt. % of polymerized units that provide the crosslinking functionality.

7. An agent according to one of claims 1 to 6, characterized in that the film-forming component b) makes up 10 to 40 wt. %, preferably 12 to 30 wt. %, based on the total floor coating agent.

8. An agent according to one of claims 1 to 7, characterized in that it additionally contains, referred to the total floor coating agent
a) up to 3 wt. % of wax dispersion, preferably based on polyethylene, and/or
b) up to 3 wt. % of flow control agents, preferably based on non-ionic surfactants, and/or
further auxiliary substances and active agents such as conventional temporary plasticizers, for example monohydric or polyhydric alcohols, conventional permanent plasticizers, for example tributoxyethyl phosphate, further conventional additives, for example preservatives as well as water.

9. An agent according to one of claims 1 to 8, characterized in that in the emulsion polymer b) the proportion of polymerized units ii) that provide the crosslinking function is such that, after crosslinking has taken place, the slope of the curve of tan δ against the temperature of the crosslinked polymer in the rubber state plateau has a value of 3.00×10-3 to −0.20×10-3.

10. An agent according to one of claims 1 to 9, characterized in that the agent is substantially free from fluorine-containing wetting agents and flow control agents.

11. A use of polyurethane in the production of which a polyol mixture has been used in which partially dehydrated castor oil with a hydroxyl number of 90 to 130 mg KOH, preferably of 110 to 125 mg KOH per g of substance is present as a constituent, in order to improve the hard-wearing behavior or durability of floor coating agents.

12. A use according to claim 11, characterized in that in the production of the polyurethane a) the partially dehydrated castor oil is present in an amount of 25 to 100 wt. % based on the polyol component of the polyurethane.
